(19) United States
(12) Patent Application Publication
(10) Pub. No.: US 2001/0006550 A1
(43) Pub. Date: Jul. 5, 2001

(54) Telecommunication device and method for converting pulse to DTMF by detecting the loop current

(76) Inventor: Georges Bettan, Montreal (CA)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/739,836

(22) Filed: Dec. 20, 2000

(30) Foreign Application Priority Data
Dec. 21, 1999 (CA) 2,292,972

(51) Int. Cl. H04M 1/00; H04M 3/00

(52) U.S. Cl. 379/377; 379/379

(57) ABSTRACT

The present invention relates to a telecommunication device and method which converts pulses generated by rotary dial phones to DTMF signals, allowing the use of CTI applications regardless of the type of telephone set used by the caller or the type of the CO switch. Pulses are identified by the device's algorithm and converted into appropriate DTMF signals. This device connects across in parallel with all the telephone lines on the subscriber side at the CO that require monitoring to detect loop current. Pulse dialing as well as overdialing from a rotary phone is thereby detected and these pulses are converted into DTMF signals, suitable for extended services. The device can also determine time and date of the call, number dialed by the user and also the length of the call from the end of the initial dialing to the disconnection of the line.

### FIELD OF THE INVENTION

The present invention relates to a telecommunication device and method, and in particular to a device which detects and monitors the loop current within a CO (Central Office) of a PSTN (Public Switched Telephone Network) and converts the incoming pulse signals to DTMF (Dual Tone Multi Frequency) signals on specific lines that require the conversion. This way all CTI (Computer Telephone Interface) applications involving call processing, such as tele-banking, voice mail, voice response etc. can be made available without having to change all rotary dial type subscriber telephone sets to DTMF telephone sets or the total switching system at the CO.

### BACKGROUND OF THE INVENTION

Various signaling protocols, international standards and different line types affect all levels of the call processing and telephony equipment market—from the manufacturer to the end user. To this day, billions of dollars are spent in the call processing industry for products that are supposed to serve all callers. Although call processing and interactive voice response systems are 100% touch-tone dependent, the majority of the world's users are still dialing in pulse, thereby making the DTMF dependent services unavailable. One way to solve the problem is to install a pulse to DTMF converter on every subscriber line. This is a very costly solution and does not work when the CO is not DTMF compatible. The next step would be to upgrade the CO switch, which is again a very costly solution.

All extended telephone services available today, such as voice mail, on-line-shopping or telephone banking are based on the use of touch-tone or DTMF dialing. The DTMF dialing uses a combination of special tones that equate to the numbers 0 to 9 plus six additional functions for a total of 16 separate sets of tones within the telephone system. Since DTMF dialing is tone based, it can be injected on top of speech audio and can be detected by special filters within the service provider's system on the monitored telephone lines. Since these tones can be easily detected on an active telephone line, (when the telephone is off-hook—i.e., when the handset is off the cradle) they can be used to control various functions within the network to activate speciality functions for the extended services. Today, the convenience of automated call processing that is being offered by CTI application has become indispensable. However, in order to use DTMF to activate the extended services, the telephone user and the COs must be DTMF capable. The user must have a DTMF telephone set and the CO must be able to decode and react to these DTMF signals. The subscriber may replace his/her telephone set with a DTMF telephone, if it is readily available in the country of residence, but if we look at the global picture, even today in most countries, Central Offices use pulse-compatible switching. Such COs can only operate with pulses to activate their connecting circuits.

1. Rotary Dial Telephone Using Pulse

Pulse dialing involves breaking the current on the line between the caller and the CO. When a number is dialed, the dial acts as a short circuit until the dial is released and lets the built-in spring return it back to the initial resting position. As it is returning, it starts to open and close the circuit in sequence to indicate the number that has been dialed. The CO switch reads these breaks in current and when the complete number is dialed, the CO starts to process the call. If the dialed number is that of a subscriber in the same area, the CO may connect the caller directly to that subscriber's line. Calls to phones further away may have to be routed through another CO, while long distance calls may go through one or more long distance switching centres (called tandems) and possibly many other COs before arriving at the destination. Thus, for completion of a call it is vital for the COs to be compatible with the subscriber's set, as well as with each other.

At the other end of the telephone circuit, in the CO, various circuits are used to decode the digits dialed into the appropriate signals needed to perform the actual connection. In pulse dial systems, this decoding is done by relay circuits, such as steppers. Once a number is dialed and a connection for audio communication is made, any overdialing, which is essential for automatic call processing, will be heard as clicks. In other words, once the connection is established, the CO switch no longer reacts to pulses sent over the voice path.

2. Touch-tone Phone

A Touch-tone phone generating DTMF pulses is similar to the rotary dial telephone described above except, instead of a pulse, various frequencies are used to correspond to each number dialed. DTMF was developed by Bell Labs in order to have a dialing system that could travel across microwave links and work with computer controlled exchanges. Each digit is composed of two separate audio tones that are mixed together; one frequency from a low frequency group and one frequency from a high frequency group. For instance, the digit 6 is generated by the combination of a low frequency of 770 Hz and a high frequency of 1477 Hz.

Touch-tone decoding is usually done by filter circuits which separate the tones by filters and then use a transistor circuit to operate a relay. There are various types of decoder circuits used and the decoding is very much different from pulse dialing. Also, unlike pulse dialing, in touch-tone dialing, overdialing can be easily sensed and can be injected into the line after appropriate filtering.

Whether the CO can handle pulse or DTMF, it is absolutely imperative that the COs be able to communicate with each other in order to put a call through and complete the circuit. In this day and age it is also essential to offer automatic call processing facilities to every subscriber in a cost-effective manner.

### DESCRIPTION OF RELATED ART

A lot of work has already been done in the area of pulse to DTMF conversion. Some of the relevant prior art is listed below.

U.S. Pat. No. 4,675,902 granted to Boeckmann on Jun. 23, 1987, relates to a high performance telephone instrument with a combination of pulse and tone dialing capacity. The circuitry allows a call through a rotary-dial or pulse telephone into a second network which is DTMF compatible.

U.S. Pat. No. 5,369,697 granted to Murray et al. on Nov. 29, 1994, describes a method and device which upon detecting passage of a period of time such as ten seconds assumes that a number has been dialed and the telecommunication device is controlled to generate only DTMF signals.

U.S. Pat. No. 4,914,690 granted to Hagedorn et al. on Apr. 3, 1990, describes a universal PBX-to-Central Office interface for standards conversion for supporting normally incompatible telephone equipment PBX environments. The system captures incoming signaling and data in any one of the three dialing modes (DTMF, MF and pulse dial) and converts them into whatever dialing mode is required by the equipment attached to the interface.

None of the aforementioned prior art references solves the problem of avoiding the enormous cost of installation of the system to be connected with the receiving end (i.e. with the subscribers' sets or with the various PBXs). Since telephone systems all over the world do not follow the same standard, it may not be advantageous to use a non-configurable converter everywhere. Moreover, the method adapted so far has been to identify the clicks of the on-hook and off-hook pulses generated which may give rise to inaccurate readings.

The present invention addresses all of the above problems and presents a device and method for conversion from pulse to DTMF and offers a universal interface between the subscriber and the CO and between the PBXs and the CO, making the implementation of the CTI extended services possible, without having to go to the expense of replacing the complete CO network with new equipment that are DTMF capable and/or changing all the subscribers' telephone sets. This proprietary device is available for installation within a CO or as an add-on to the user's equipment outside the CO. The uniqueness of the device is that it is installed in parallel with the analog lines at the CO on the subscriber side and is made responsible for sensing the loop current. A slightly modified version of the device can be used in a telephone system environment, for example a wireless telephone system, where the subscriber cannot connect himself to the telephone switching system because he has a rotary dial phone. In this case the present device can be installed between the rotary dial telephone and the telephone jack and the subscriber will be able to use the telephone system in order to access CTI extended services.

### SUMMARY OF THE INVENTION

Broadly, the present invention provides a telecommunication device enabling a user to access an automated call processing system which requires DTMF in a telephone network environment where one or more of a subscriber telephone set or a Central Office is not DTMF capable.

According to the present invention, there is provided a telecommunication device for use in a telephone network system, for converting pulse dialed digits in subscriber lines at a CO end, into DTMF signals, comprising: a plurality of loop current detection means, wherein each loop current detection means constantly monitors a loop current in a subscriber line at the CO end and detects a presence of pulses when the digits are dialed and subsequently generates signals; a PLSI (programmable large scale integrated circuit) unit for accepting the signals from the plurality of the loop current detection means in parallel and converting all parallel signals into a serial stream; a DSP (digital signal processing) unit for accepting the serial stream from the PLSI unit and converting the serial stream into the DTMF signals; a DAC (digital to analog converter) unit for accepting the DTMF signals from the DSP unit and converting the DTMF signals into corresponding analog signals; and a plurality of line injection units for accepting the analog signals from the DAC units and injecting the analog signals into the subscriber lines, wherein the telecommunication device is connected in parallel with the subscriber lines at the CO end of the telephone network system.

According to a further aspect of the present invention, the pulse dialed digits are overdialed pulse digits.

The invention also provides a telecommunication method for converting a pulse dialed digit into a DTMF signal in a subscriber line at a CO end, comprising the following steps of: constantly monitoring a loop current in the subscriber line at the CO end; detecting a presence of pulses when a digit is dialed and counting said pulses; detecting delays between the pulses; converting the pulses into the DTMF signal; converting the DTMF signal into an analog signal; and injecting the analog signal into the subscriber line.

According to another aspect of the present invention, there is provided a telecommunication device enabling a user to access an automated call processing service which requires DTMF signal in a telephone network environment, such as, wireless, wherein a subscriber telephone set a not DTMF capable. The telecommunication device for use in a telephone network system, for converting a pulse dialed digit in a subscriber line at a subscriber's end, into a DTMF signal, comprising: a loop current detection means for constantly monitoring a loop current in the subscriber line at the subscriber's end and detecting a presence of pulses when the digit is dialed and subsequently generating a signal; a microprocessor for accepting the signal and converting the signal into the DTMF signal; a DAC (digital to analog converter) unit for receiving the DTMF signal from the microprocessor and generating an appropriate analog signal; and an injection circuit unit for accepting the analog signal from the DAC unit and for injecting the analog signal into the subscriber line, wherein the telecommunication device is connected in parallel with the subscriber line at the subscriber's end.

According to a further aspect of he present invention, the pulse dialed digit is an overdialed pulse digit.

According to another aspect of the present invention, there is provided a telecommunication method enabling a user to access an automated call processing service in a telephone network environment, such as, wireless, wherein a subscriber telephone set is not DTMF capable, said method for converting a pulse dialed digit in a subscriber line at a subscriber's end, into a DTMF signal, comprising the following steps of: constantly monitoring a loop current in the subscriber line at the subscriber's end; detecting a presence of pulses when the digit is dialed and counting the pulses; detecting delays between the pulses; converting the pulses into the DTMF signal; converting the DTMF signal into an analog signal; and injecting the analog signal into the subscriber line.

The above and other objects, features and advantages of the present invention will become apparent from the following description and the appended claims, taken in conjunction with the accompanying drawings.

### BRIEF DESCRIPTION OF THE DRAWINGS

FIG. 1 is a block diagram showing the connection between a subscriber line at the CO end and a telecommunication device according to an embodiment of the present invention;

FIG. 2 is a general block diagram describing the various components of the telecommunication device;

FIG. 3 is a flow chart for describing the steps involved in the conversion operation;

FIG. 4 is a block diagram showing connection for the telecommunication device in a wireless environment; and

FIG. 5 is a block diagram showing the basic contents of the telecommunication device in a wireless environment.

### DETAILED DESCRIPTION OF THE INVENTION

The main principle of the present device, based on detecting and analysing the loop current signals of the telephone line at the CO end, will now be described.

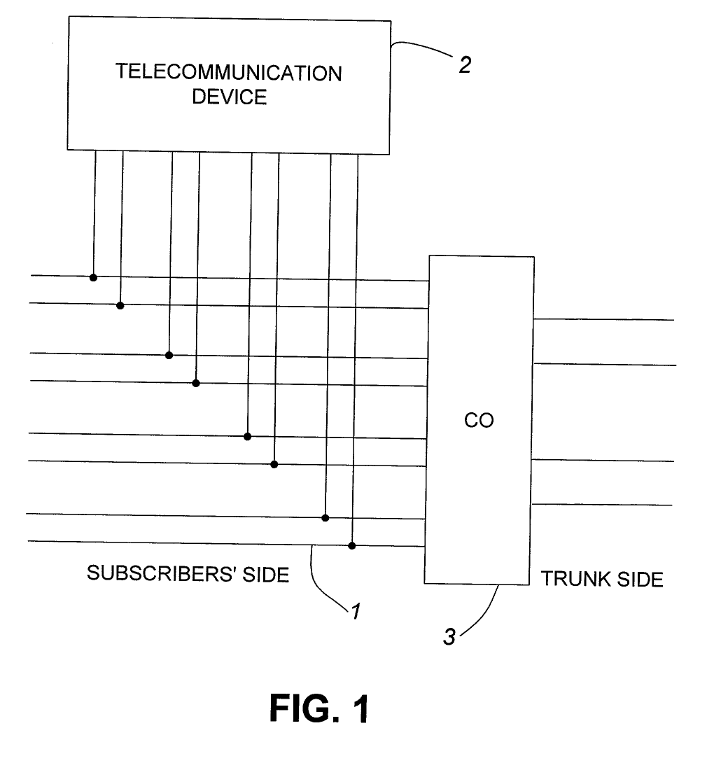

Referring first to FIG. 1 there is shown a block diagram showing an embodiment of the present invention having the connections between line 1 of the CO 3 and the telecommunication device 2. The device 2, having a very high impedance, is connected in parallel with line 1 at the CO 3 subscriber end. It is not necessary to make any changes in line 1 in order to install the device 2.

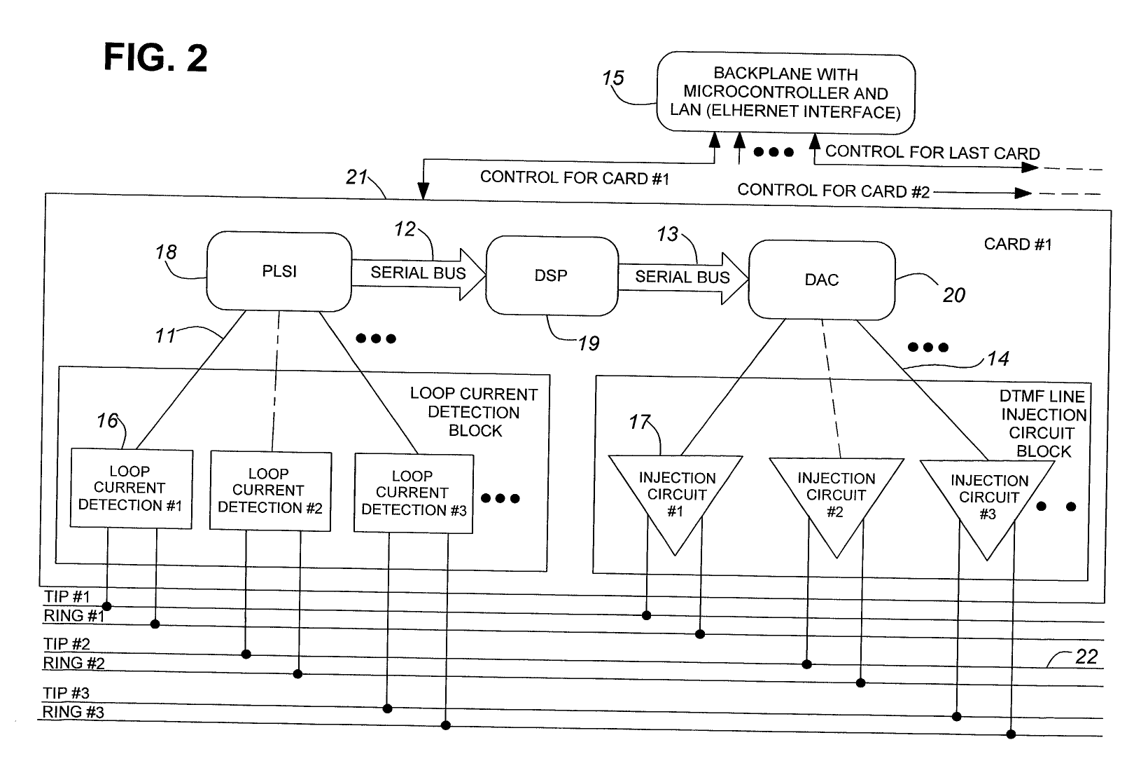

FIG. 2 is a general block diagram showing the internal components of the telecommunication device 2. The device 2 is a modular platform comprising one backplane 15 and multiple line interface cards 21, only one of which is shown here. The backplane 15 is used for communication between cards and the outside world for configuration and statistical purposes. The backplane 15 uses a micro-controller, a net (such as Ethernet) interface, a communication port (such as an RS-232) interface and card connectors to connect the backplane 15 with each card 21. Each card 21 is composed of a plurality of loop current detectors 16, Programmable Large Scale Integration (PLSI) circuit 18, Digital Signal Processors (DSP) 19, Digital to Analog Converters (DAC) 20 and a plurality of DTMF line injection circuits 17. Each card 21 comes with its own set of loop current detectors 16 and line injection circuits 17, each loop current detector 16 and line injection circuit 17 being dedicated to one telephone line.

As soon as dialing or overdialing takes place, the status of the loop current is detected by means of the loop current detector 16, a one bit message 11 is sent to the PLSI 18. The PLSI 18 takes all parallel messages from all loop current detectors 16 and converts them into a serial stream and sends it to the DSP 19 over a serial bus 12. The DSP 19 analyses the loop current detection pattern and decides which digit had been dialed so that it can generate the appropriate DTMF signal. The DTMF is generated numerically by the DSP 19 and sent via a serial bus 13 to a DAC 20. The DAC 20 converts the DTMF signal into analog signal 14 and sends it to a line injection circuit 17. The line injection circuit 17 injects the analog signal 14 into the CO line 22 for the use of other COs, DTMF compatible PBXs or subscribers. In addition to detection and conversion of pulse dialing from a rotary phone by the user, overdialing is also detected and converted into DTMF signals in real time and the overdialed numbers are injected into the line for use by service providers connected to these lines requiring DTMF signals for their extended services.

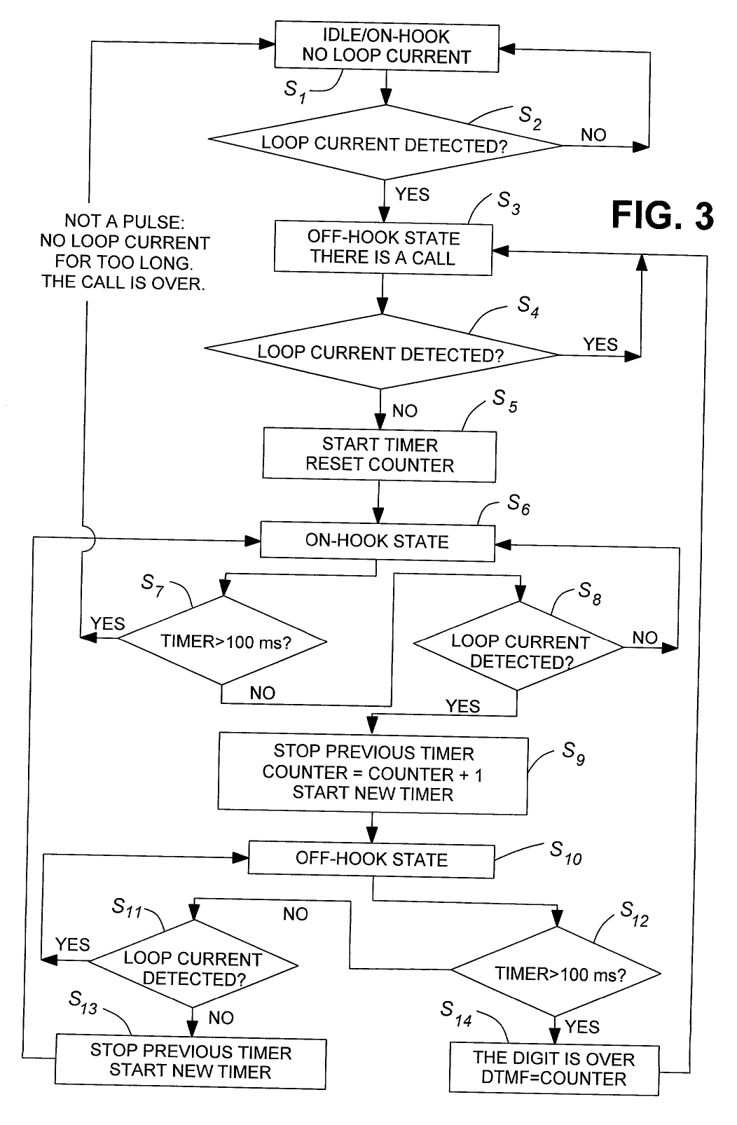

Next, with reference to the flow chart of FIG. 3, the sequence of operation will be described. At the initial idle state, the telephone is on hook, there is no loop current (S1) and the system is constantly monitoring for the detection of loop current (S2). If no loop current is detected, the idle state is maintained, but as soon as a loop current is detected, the state machine goes to off hook state and a new call is detected (S3). However, the loop current is constantly monitored (S4) and the absence of the loop current indicates two possibilities. One, indicating that there may be a pulse signal and the other indicating an end of the call. As soon as the loop current ceases to exist, a timer is started and a counter is reset (S5). If on hook state is detected, i.e., if no loop current is detected (S6) for a time period of typically 100 ms in the timer (S7), the call is considered to be over and the state machine goes to idle state (S1). On the other hand, if before the expiry of 100 ms, a loop current is detected (S8), the previous timer is stopped, a new timer is started and the counter is incremented by 1 (S9). This state indicates that a first pulse of a dialed digit has been detected and the state machine is in off hook state again (S10). Once the time in the new timer is greater than 100 ms, the digit is considered to be over and the number of pulses detected corresponds to the number which is to be converted into DTMF (S14). The state machine then goes to off hook (S3) and monitors the loop current all over again. On the other hand, if before the expiry of the 100 ms time period, the loop current ceases to exist (S11) i.e., the telephone is on hook state, the previous timer is stopped and a new timer is started (S13). The state machine goes to on hook state (S6) and monitors the loop current in accordance with the timer. This cycle is repeated until the end of the digit is found. Each digit dialed is converted into a DTMF signal, and then each time a new digit is dialed, the cycle of conversion starts all over again resetting the timer and the counter.

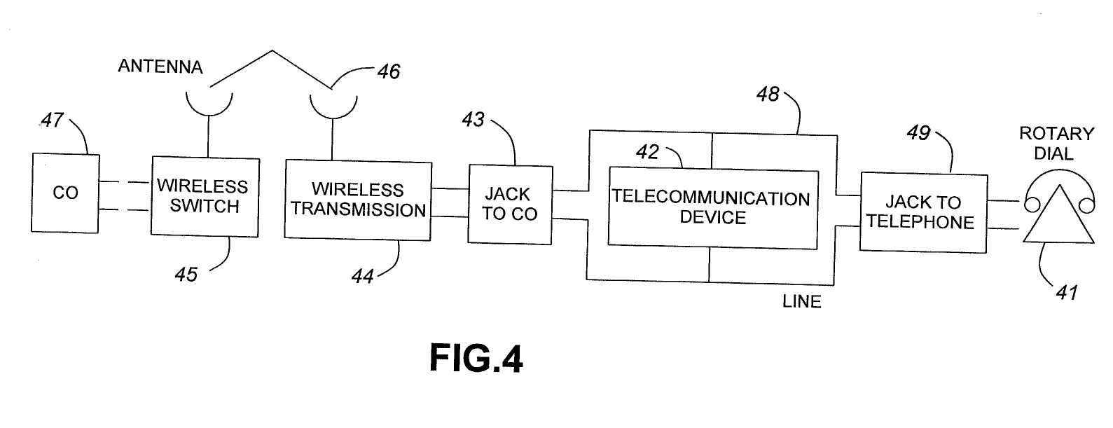

Next, with reference to FIG. 4, another embodiment of the present invention will be described in conjunction with a wireless environment. A subscriber's telephone 41 is connected to a CO 47 via radio-trunking and wireless switching. DTMF numbers dialed and numbers called are sent and received by the subscriber's telephone set 41 with the help of an antenna 46. If the subscriber 41 has a rotary dial pulse system, the subscriber will not be able to connect himself with the CO. To overcome this problem, the present invention can be used with slight modification. The telecommunication device 42 can be modified and can be installed in parallel with the telephone line 48 and placed between the jack to CO 43 and the jack to telephone 49 which is connected with the telephone 41, the telecommunication device 42 being used as a single line pulse to DTMF converter.

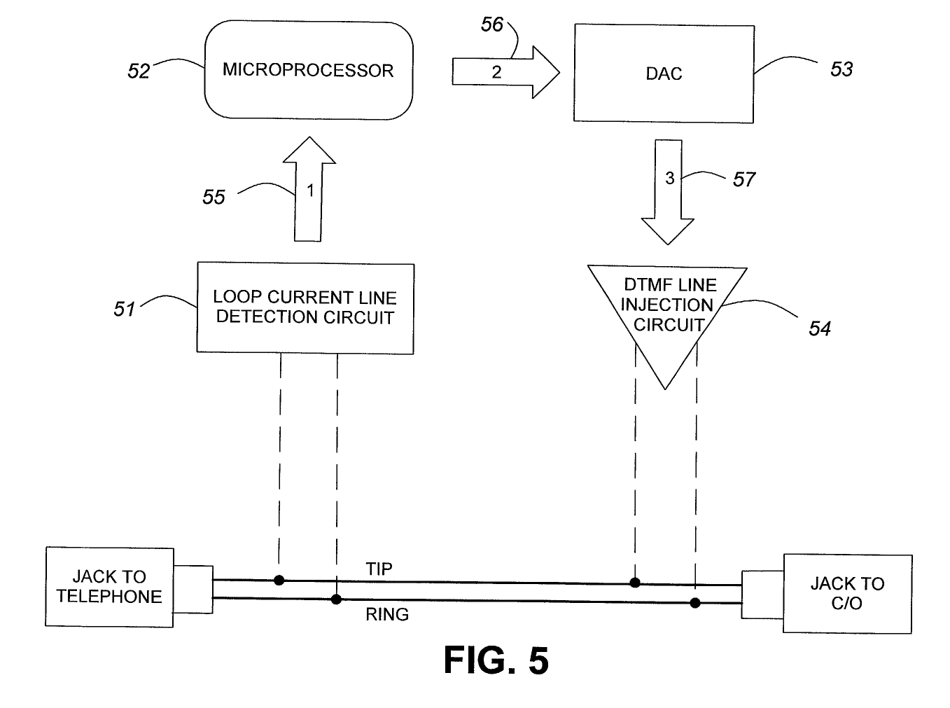

This operation is explained with the help of the block diagram in FIG. 5. A loop current line detection circuit 51 detects the loop current and if the loop current is detected, sends the information to the microprocessor 52 by means of a one-bit message 55. The microprocessor 52 determines if a digit has been dialed and programs the digital to analog converter (DAC) 53 via address and data lines 56 to generate the appropriate DTMF signal. The converted signal is then taken to the DTMF line injection circuit 54 via bus 57 and after processing by the DTMF line injection circuit 54, the signal is then injected into the line. Each digit dialed by the rotary dial telephone including overdialing will be converted into DTMF signals in real time and be sent through the antenna by wireless communication.

Line noise and crosstalk have little or no effect on pulse to tone conversion as pulses do not appear in the voice path. Hence the electrical pulses in the loop current sensed the device are highly accurate. In terms of efficiency, for example, typically with one device 4000 lines can be served. The device can also determine time and date of the call, number dialed by the user and also the length of the call from the end of the initial dialing to the disconnection of the line using conventional methods.

Thus, the present invention offers compatibility between a subscriber's telephone set, the CO and the PBXs irrespective of their pulse or DTMF capability, so that it is possible to implement all the automated call processing features for subscribers to enjoy without having to replace the telephone sets or the CO equipment.

Different countries have different standards in terms of voltage, delay, etc. of the pulse generated in the pulse dial system, and this telecommunication device is configurable and compatible with all standards.

It will be obvious to those skilled in the art that numerous modifications of the present invention may be made without departing from the spirit of the present invention which is limited only by the scope of the claims appended hereto.

What is claimed is:

1. A telecommunication device for use in a telephone network system, for converting pulse dialed digits in subscriber lines at a CO end, into DTMF signals, comprising:
a plurality of loop current detection means, wherein each loop current detection means constantly monitors a loop current in a subscriber line at the CO end and detects a presence of pulses when the digits are dialed and subsequently generates signals;
a PLSI (programmable large scale integrated circuit) unit for accepting the signals from the plurality of the loop current detection means in parallel and converting all parallel signals into a serial stream;
a DSP (digital signal processing) unit for accepting the serial stream from the PLSI unit and converting the serial stream into the DTMF signals;
a DAC (digital to analog converter) unit for accepting the DTMF signals from the DSP unit and converting the DTMF signals into corresponding analog signals; and
a plurality of line injection units for accepting the analog signals from the DAC units and injecting the analog signals into the subscriber lines,
wherein the telecommunication device is connected in parallel with the subscriber lines at the CO end of the telephone network system.

2. A telecommunication device according to claim 1, wherein the pulse dialed digits are overdialed pulse digits.

3. A telecommunication device according to claim 1, wherein each loop current detection means has a high impedance.

4. A telecommunication device according to claim 1, wherein each loop current detection means generates a one bit signal when the loop current is detected.

5. A telecommunication device according to claim 1, further comprising a microcontroller for controlling operations for configuration and statistical purposes.

6. A telecommunication device according to claim 1, further comprising a network interface for interfacing with a network.

7. A telecommunication device according to claim 1, further comprising a communication port interface to interface with a communication port.

8. A telecommunication method for converting a pulse dialed digit into a DTMF signal in a subscriber line at a CO end, comprising the following steps of:
constantly monitoring a loop current in the subscriber line at the CO end;
detecting a presence of pulses when a digit is dialed and counting said pulses;
detecting delays between the pulses;
converting the pulses into the DTMF signal;
converting the DTMF signal into an analog signal; and
injecting the analog signal into the subscriber line.

9. A telecommunication method according to claim 8, wherein the pulse dialed digit in the subscriber line at the CO end is an overdialed pulse digit.

10. A telecommunication device for use in a telephone network system, for converting a pulse dialed digit in a subscriber line at a subscriber's end, into a DTMF signal, comprising:
a loop current detection means for constantly monitoring a loop current in the subscriber line at the subscriber's end and detecting a presence of pulses when the digit is dialed and subsequently generating a signal;
a microprocessor for accepting the signal and converting the signal into the DTMF signal;
a DAC (digital to analog converter) unit for receiving the DTMF signal from the microprocessor and generating an appropriate analog signal; and
an injection circuit unit for accepting the analog signal from the DAC unit and for injecting the analog signal into the subscriber line,
wherein the telecommunication device is connected in parallel with the subscriber line at the subscriber's end.

11. A telecommunication device according to claim 10, wherein the pulse dialed digit in the subscriber line at the subscriber's end is an overdialed pulse digit.

12. A telecommunication device according to claim 10, wherein the loop current detection means has a high impedance.

13. A telecommunication device according to claim 10, wherein the loop current detection means generates a one bit signal when the loop current is detected.

14. A telecommunication device according to claim 10, wherein the microprocessor programs the DAC unit via address and data lines.

15. A telecommunication device according to claim 10, wherein the telephone network system is a wireless system.

16. A telecommunication method for converting a pulse dialed digit in a subscriber line at a subscriber's end, into a DTMF signal using a device as defined in claim 10, comprising the following steps of:
constantly monitoring a loop current in the subscriber line at the subscriber's end;
detecting a presence of pulses when the digit is dialed and counting the pulses;
detecting delays between the pulses;
converting the pulses into the DTMF signal;
converting the DTMF signal into an analog signal; and
injecting the analog signal into the subscriber line.

17. A telecommunication method according to claim 16, wherein the pulse dialed digit in the subscriber line at the subscriber's end, is an overdialed pulse digit.
